(19) United States
(12) Patent Application Publication
(10) Pub. No.: US 2004/0043280 A1
(43) Pub. Date: Mar. 4, 2004

(54) Cell assembly for an electrochemical energy converter and method for producing such a cell assembly

(76) Inventors: Marc Steinfort, Lindenstrasse (DE); Marc Bednarz, Walleitner Weg Taufkirchen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/416,801

(22) PCT Filed: Nov. 13, 2001
(86) PCT No.: PCT/EP01/13088

(30) Foreign Application Priority Data
Nov. 15, 2000 (DE) 100-56-535.2

(51) Int. Cl. H01M 8/24; H01M 2/08; H01M 4/86

(52) U.S. Cl. 429/38; 429/35; 429/44

(57) ABSTRACT

A cell arrangement for an electrochemical energy converter, especially a fuel cell arrangement with cells (12) arranged in the form of a cell stack (10), is described. Each of the cells (12) comprises an anode (1), a cathode (2), and an ion-conducting layer (3) positioned between the anode and the cathode, and the cells are separated from on another and electrically contacted via bipolar plates (4). According to the invention, current collectors (4a, 4b) provided for contacting the anodes (1) or the cathodes (2) are formed by a porous structure, in which flow paths (16, 17) for conducting anode and/or cathode medium are contained.

### BACKGROUND AND SUMMARY OF THE INVENTION

The present invention relates to a cell arrangement, especially a fuel cell arrangement, and to a method for producing the arrangement.

Fuel cell arrangements, especially arrangements of molten carbonate fuel cells, in which a number of fuel cells, each comprising an anode, a cathode, and a porous electrolyte matrix positioned between the anode and the cathode, arranged in the form of a fuel cell stack, are known in the art. In these arrangements, the individual fuel cells are separated from one another and electrically contacted by bipolar plates. Current collectors are provided on each of the anodes for electrical contacting of the anodes. For conducting fuel gas to them, just as current collectors are provided on each of the cathodes for the electrical contacting of the cathodes, and for conducting cathode gas to them, furthermore, means are provided for directing the fuel gas and the cathode gas to and from the fuel cells.

Known fuel cell arrangements of this type are relatively costly to produce, and thus are wasteful, as they contain a multitude of individual components, some of which require a large number of manufacturing steps.

An object of the invention is to provide a cell arrangement for an electrochemical energy converter that can be efficiently produced at lower cost. An additional object is a disclosure of a method for producing a cell arrangement of this type.

These objects are attained with the cell arrangement and with a method for producing a cell arrangement as claimed.

A cell arrangement of the invention comprises cells arranged in the form of a cell stack, wherein each of the cells contains an anode, a cathode, and an ion-conducting layer positioned between the anode and the cathode, with the cells being separated from one another and electrically contacted via bipolar plates. Current collectors are provided on each of the anodes for the electrical contacting of the anodes, and for conducting anode medium to the anodes, and current collectors are provided on each of the cathodes for the electrical contacting of the cathodes, and for conducting cathode medium to the cathodes. In addition, means are provided for supplying anode and cathode medium to the cells, and removing them from the cells. According to the invention, the current collectors for the anode and/or cathode are formed by a porous structure that supports the anode and/or cathode, in which flow paths for directing the anode and/or cathode medium are contained. The advantage of current collectors of this design is that they are much simpler and can be produced with fewer manufacturing steps than current collectors that are traditionally used with this type of cell arrangement. The cell arrangements of the invention can be used with fuel cells and with electrolyzers.

Advantageously, the porous structure that forms the current collectors is comprised of a sintered material, preferably a porous nickel-sintered material. The porous structure can include one or more layers, which may have the same or different porosity and thickness. The layers may differ in terms of pore size, pore orientation, material, and total solids.

Advantageously, the porous structure that forms the current collectors is comprised of a nickel-foam material having a total solids content of 4% to ca. 75%, preferably 4% to 35%.

The surface of the porous structure is preferably flat or profiled. The profiling can serve to guide the flow medium and/or can be used to hold a catalyst.

In accordance with one particularly advantageous additional development of the cell arrangement of the invention, the anode and/or the cathode are provided as a layer on the porous structure that forms the current collectors. This results in a further simplification of production. In the design that contains several layers, the structure of the layer that forms the support for the anode or cathode may differ in terms of its porosity, material, and total solids from the layer that faces away from the electrodes.

Preferably, the flow paths for conducting the anode and/or cathode medium are formed by channels. In fuel cells, the anode medium is a fuel gas, and the cathode medium is a cathode gas. In the case of an electrolyzer, the anode or cathode medium is comprised of a base, which is fed into a base circuit. One electrolyzer of this type is presented, for example, in unpublished German patent application DE 101 50 557.4.

The channels used to conduct the anode and/or cathode medium are preferably provided on the surface of the porous structure that forms the current collectors and faces away from the associated electrodes.

In accordance with another preferred improvement of the cell arrangement of the invention, the bipolar plates contain flat bipolar sheets positioned between the current collectors of adjacent cells. This results in an additional simplification, and a reduction in the cost of producing the cell arrangement.

In accordance with another highly advantageous further improvement on the cell arrangement of the invention, the ion-conducting layer is designed as a layer on the anode or cathode. This results in a further simplification of the cell arrangement and thus a reduction in production costs.

In accordance with another advantageous further improvement on the cell arrangement of the invention, a layer of a catalyzing material is provided on the porous structure that forms the current collectors and supports the anode. In this manner, the catalytic device can be provided inside the cell arrangement simply.

In accordance with one preferred design of the invention, the half-cell formed by the anode or cathode and by the current collector that supports them is laterally sealed by a sealing element, especially in the form of a U-shaped profiled piece, which fits around the anode or cathode and the porous structure that forms the current collectors.

A shoulder preferably is formed on the surface of the anode or cathode and the current collector that holds it, such that the shoulder corresponds to the material thickness of the sealing element, so that the surface of the anode or cathode and the current collector is smoothly extended by the surface of the sealing element.

It is especially advantageous if the cell stack is in a vertical or horizontal orientation during operation, and if the prestressing force of the cells is low and can be variably adjusted to the operating condition of the cell arrangement. Especially with a horizontal orientation of the cell stack, all cells in this orientation are subject to the same prestressing force, which can be adjusted to a low value, so that less stringent requirements with respect to compression strength can be placed on the materials used as components in the cells. A horizontal orientation is especially well suited to a smaller thickness of the porous structure of the current collectors. With a vertical arrangement of the cell stack, due to the higher weight load placed on the lowest cells, a greater thickness for the porous structure should be chosen.

It is preferably provided that the means for generating the prestressing force generate a high level of prestressing force when the cell arrangement is started up, after which they reduce the prestressing force. The advantage here is that when the cell arrangement is started from rest, the individual components can settle, and manufacturing tolerances can be balanced, while afterward, during operation of the cell arrangement, a reduced level of prestressing force results in a longer lifespan for the cells. Preferably, the prestressing force is regulated such that the compressive forces within the stack will remain constant after the cell arrangement has been started up.

A method for producing a cell arrangement of the type described above provides that the current collectors are produced as a porous structure made of a sintered material, especially a porous nickel-sintered material, and that the electrodes are applied as a layer on the current collectors.

An advantage of this method is that the cell arrangement is easy to produce, at low cost, and, thus, is cost-effective.

Preferably, the porous structure that forms the current collectors is made of a nickel-foam material having a total solids content of 4% to ca. 75%, preferably 4% to 35%, via a carbonyl process, deposition, galvanization, or foaming.

The porous structure that forms the electrodes can be formed via pouring, form casting, compression molding, or extrusion molding of a liquid, paste-like, or plastic raw material, and then dried and sintered.

In accordance with one preferred design of the method of the invention, the layer that forms the electrodes is applied directly by spraying a sprayable electrode raw material onto the porous structure that forms the current collectors, or adjacent components.

Alternatively, the layer that forms the electrodes can be applied by wiping a viscous or paste-like electrode raw material onto the porous structure that forms the current collectors, or adjacent components.

In accordance with another alternative, the layer that forms the electrodes can be applied by pouring, solution casting, or dipping a liquid electrode material onto the porous structure that forms the current collectors, or adjacent components.

Finally, an additional alternative provides for the layer that forms the electrodes to be produced separately, and then applied to the porous structure that forms the current collectors.

One additional improvement of the method of the invention provides for a catalyzing material to be applied to the porous structure that supports the anodes and forms the current collectors for the same. The advantage here is a simple and cost-saving method for producing a catalyst for the internal reforming of the fuel gas.

The catalyzing material can preferably be applied in the form of a layer via spraying.

In accordance with another, highly advantageous further improvement of the method of the invention, the ion-conducting layer is produced by applying a layer of a liquid, viscous, paste-like, or plastic material to the layer that forms the anodes or cathodes. This enables a further simplification and cost-reduction to the production of the cell arrangement.

Preferably, the matrix can be produced via spraying, wiping, pouring, solution casting, or dipping.

In accordance with one alternative, the matrix can be produced separately as a layer of an ion-conducting material, and then applied to the layer that forms the anodes or cathodes.

In accordance with an additional improvement of the method of the invention, the matrix is produced in the form of a two-layer matrix comprising two layers.

Preferably, the matrix is applied to the layer that forms the cathodes.

In accordance with another improvement of the method of the invention, channels are included in the porous structure that forms the current collectors, as flow paths for conducting anode and/or cathode medium or fuel gas, and/or cathode gas. Such channels serve to distribute the appropriate medium over the porous structure that forms the current collector, wherein the anode or cathode medium is then distributed from the channels over inner flow paths formed by the porosity of the current collectors.

Preferably, the channels are formed on the surface of the porous structure that forms the current collectors that faces away from the electrodes.

In accordance with one design of the method of the invention, the channels are created already during the shaping of the porous structure that forms the current collectors.

In accordance with one advantageous alternative to this, the channels are created on the porous structure that forms the current collectors in a subsequent step via press forming, rolling, or pressing.

Below, design examples of the cell arrangement of the invention and the method of the invention for producing the cell arrangement will be described in greater detail, with reference to the drawings of a fuel cell arrangement.

### BRIEF DESCRIPTION OF THE DRAWINGS

FIG. 1 is a diagrammatic partial representation of a fuel cell in accordance with one design example of the invention;

FIG. 2 is a diagrammatic, enlarged cross-sectional view of a section of a porous structure that forms a current collector, with an electrode positioned thereon, in accordance with one design example of the invention;

FIG. 3 is a perspective view of the porous structure that forms the current collector shown in FIG. 2, on a reduced scale;

FIG. 4 is an enlarged and partially perspective view of a cross-section of a fuel half cell, with a current collector formed by the porous structure, and the electrode supported by the current collector, together with a sealing element for the lateral sealing of this half cell in accordance with a further design example of the invention;

FIG. 5 is a perspective view of the half-cell shown in FIG. 4, together with a separator plate, in accordance with one design example of the invention;

FIGS. 6a and 6b provide a diagrammatic representation, which shows the horizontal orientation of the fuel cell stack, in accordance with one aspect of the invention;

FIGS. 7, 8, and 9 are diagrammatic, partially perspective representations of steps in the process of producing an electrode on a porous structure that forms the current collector, in accordance with design examples of the invention;

FIG. 10 is a diagrammatic representation, illustrating the production of the electrolyte matrix in accordance with a further design example of the invention;

FIG. 11 is a diagrammatic representation, illustrating the production of a catalytic coating on the porous structure that forms the current collector, in accordance with an additional design example of the invention;

FIG. 12 is a cross-sectional representation illustrating the production of gas-conducting channels, in accordance with a further design example of the invention; and

FIG. 13 is a cross-sectional representation of a cell having two-layer current collectors.

### DETAILED DESCRIPTION OF THE INVENTION

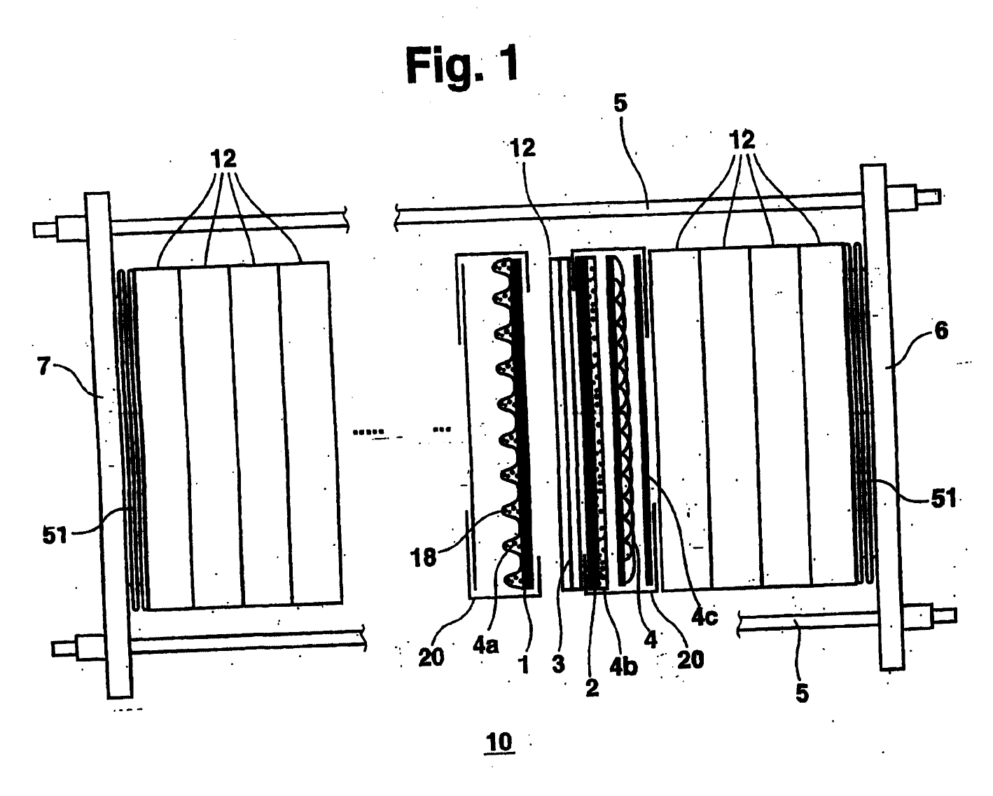

In FIG. 1, the reference number 10 refers to a fuel cell stack, comprised of a number of fuel cells 12. Each of these cells contains an anode 1, a cathode 2, and an electrolyte matrix 3, positioned between the anode and the cathode. Adjacent fuel cells 12 are separated from one another by bipolar plates 4, which serve to conduct the flows of a fuel gas B and an oxidation gas O, separately from one another, over the anode 1 or the cathode 2 of the fuel cells 12. In this, the anode 1 and the cathode 2 of adjacent fuel cells 12 are separated from one another in terms of gas technology by the bipolar plates; however they are in electrical contact with one another via respective current collectors 4a, 4b, namely one current collector 4a on the anode 1 and one current collector 4b on the cathode 2. The fuel cell stack 10 is prestressed in a lengthwise direction via tie bars 5, which are firmly secured between end plates 6, 7. The prestressing force can also be induced and adjusted, e.g., using bellows seals 51 and springs.

Very generally, the current collectors 4a, 4b are formed by a porous structure, which supports the anode 1 or the cathode 2. A porous structure of this type may be provided for only the anodes 1 or for only the cathodes 2, or for both anodes 1 and cathodes 2. In the porous structures that form the current collectors 4a, 4b, flow paths serve to direct and distribute the fuel gas or the cathode gas to the appropriate electrodes 1, 2.

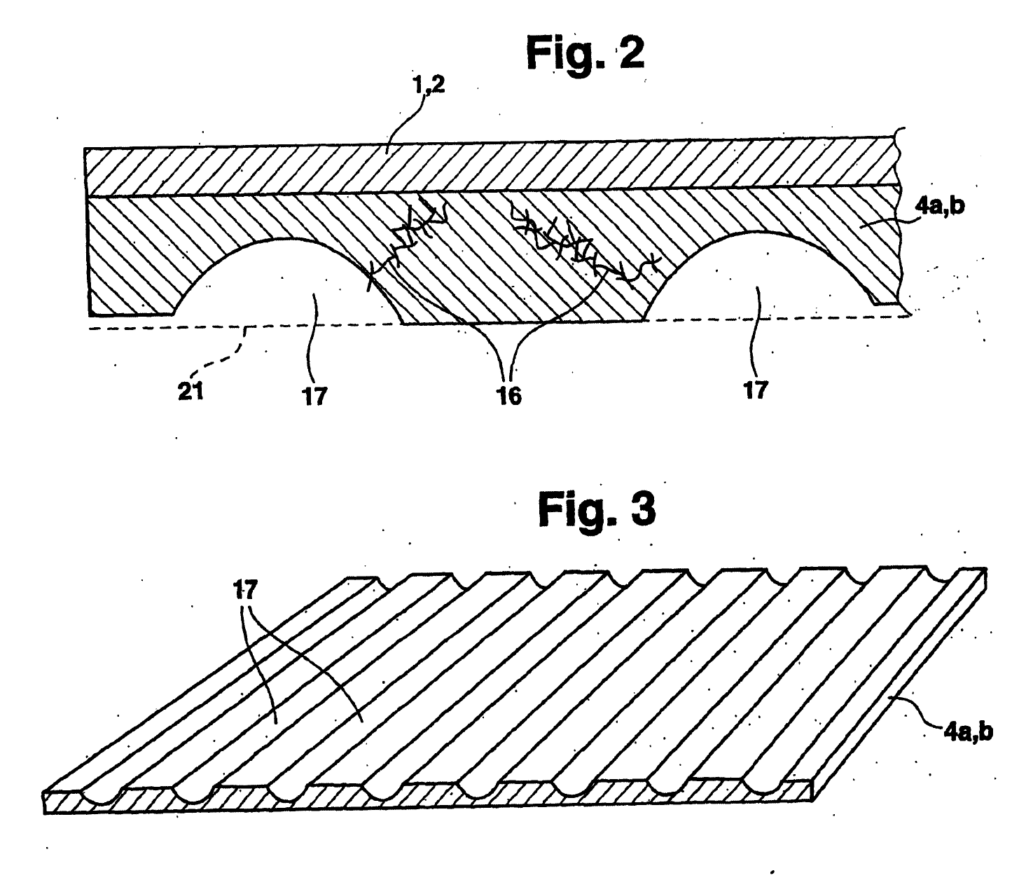

As can be seen in FIG. 2, which shows an enlarged cross-sectional diagram of a current collector 4a, 4b formed by such a porous structure, with an electrode 1, 2 applied thereon, these flow paths designed for directing fuel gas or cathode gas are formed by (microscopic) flow paths 16, which are present as a result of the porosity within the porous structure, and by (macroscopic) gas channels 17, which are formed in or on the porous structure. In the design example illustrated in FIG. 2, these channels 17 are located on the surface of the porous structure that forms the current collectors 4a, 4b that faces away from the associated electrode 1, 2.

FIG. 3 is a perspective illustration of a current collector 4a, 4b, in which the course of the channels 17 on the surface of the porous structure is visible.

The porous structure that forms the current collectors 4a, 4b is preferably made of a sintered material, preferably a porous nickel-sintered material. The type of porous nickel-sintered material in the design example described here is a nickel-foam material that has a total solids content of 4% to ca. 75%. The surface of the porous structure 4a, 4b, the surface that faces toward the electrode 1, 2, and the surface that faces away from the electrode are all flat, so that the porous structure forms a plane-parallel plate, with the exception of the flow channels 17 that are embedded in the surface that faces away from the electrode 1, 2.

The porous structure that forms the current collectors 4a or 4b can be produced via a carbonyl process, deposition, galvanization, or foaming. Nickel can be deposited on a formed, organic precursor foam via galvanic, chemical, PVD and CVD processes.

In the carbonyl process, deposition is accomplished via the Mond process. In a foaming process, metal powder suspensions are used.

As FIG. 2 further shows, the electrodes 1, 2, in other words the anode 1 or the cathode 2, are provided as a layer on the porous structure that forms the current collectors 4a or 4b. On the surface of the porous current collector structure that contains the channels 17, a sealing film 21 may be provided, which seals the channels 17 flush with the surface of the porous structure.

The electrodes 1, 2 or the layer that forms said electrodes can generally be produced in very different ways, as described in reference to the FIGS. 7, 8 and 9. The starting point for the production of the electrodes is the porous structure that forms the current collectors 4a, 4b, as is shown in FIG. 7.

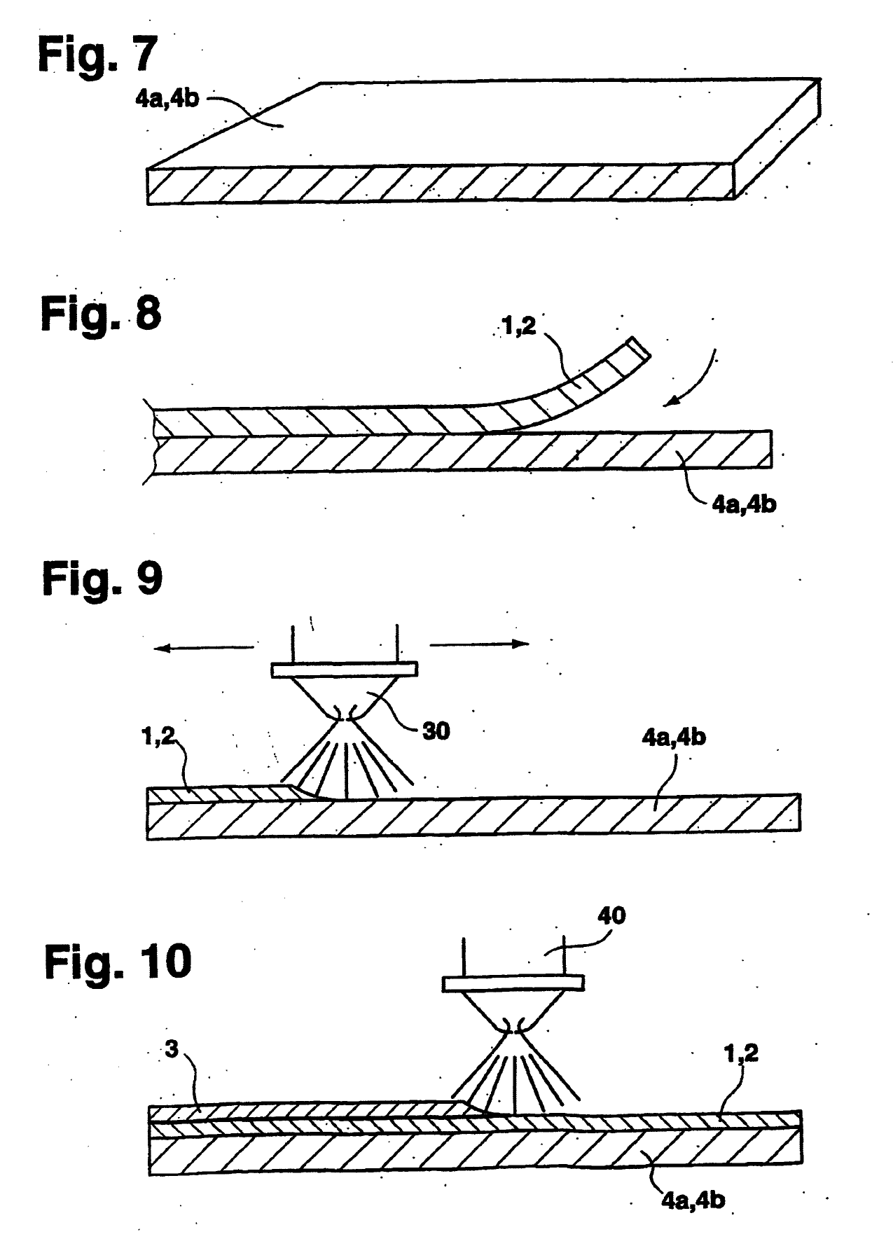

The layer that forms the electrodes 1, 2 is applied to this porous structure that forms the current collectors 4a, 4b, as is shown very generally in FIG. 8. Basically, all of the active, sprayed, or coated layers can be generated on the adjacent components. Thus, for example, the anode and/or the cathode can be sprayed directly onto the matrix.

In the design example shown in FIG. 9, the layer that forms the electrodes 1, 2 is applied by spraying a sprayable, i.e. liquid, viscous, or paste-like electrode material onto the porous structure that forms the current collectors 4a, 4b.

Alternatively, the layer that forms the electrodes 1, 2 can be applied by wiping a viscous, paste-like, or plastic electrode raw material onto the porous structure of the current collectors 4a, 4b.

In accordance with an additional alternative, the layer that forms the electrodes 1, 2 can be applied by pouring, solution casting, or dipping a liquid electrode raw material onto the porous structure that forms the current collectors 4a, 4b.

In accordance with another alternative, the layer that forms the electrodes 1, 2 can first be produced separately and then applied to the porous structure that forms the current collectors 4a, 4b, similar to the method shown in the general representation in FIG. 8.

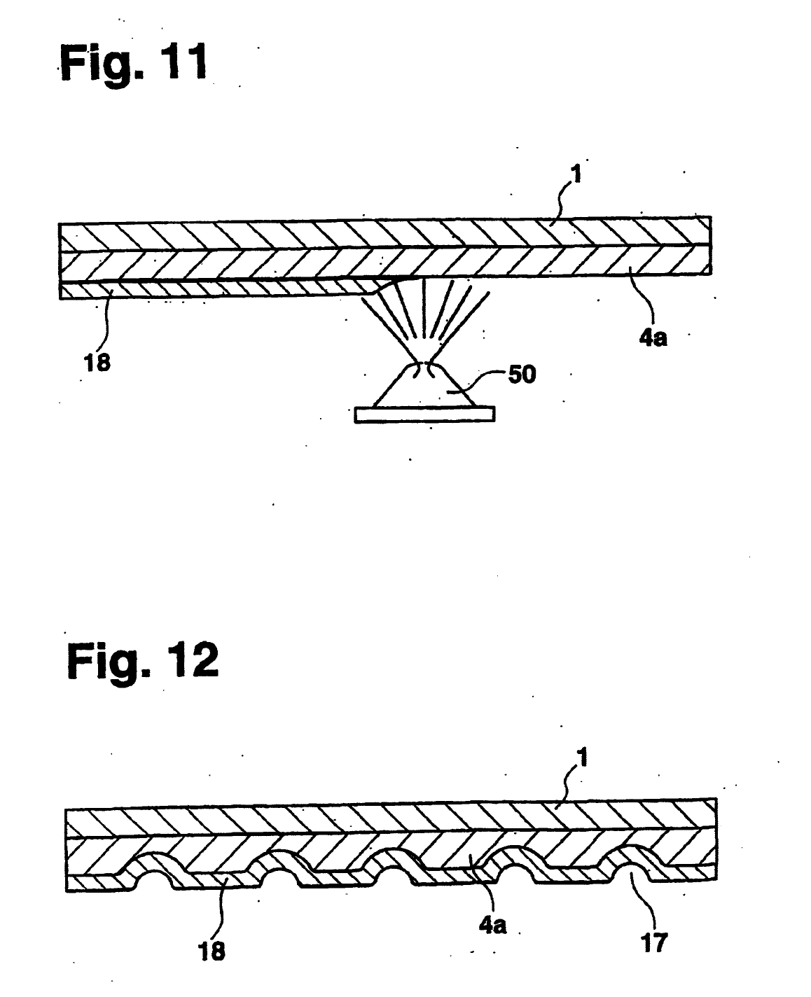

As is shown in FIG. 11, in accordance with a further design example of the invention, a layer 18 of a catalyzing material is applied to the porous structure that forms the current collector 4a of the anode 1, wherein the material promotes the internal reforming of the fuel gas inside the fuel cell stack immediately before it reaches the anode 1. In the design example shown here, this catalyzing material 18 is applied in the form of a layer applied using a spray head 50.

In accordance with a further design example of the invention shown in FIG. 10, the electrolyte matrix 3 is produced in the form of a layer on the layer that forms the anodes 1 or the cathodes 2. This can be accomplished by applying a layer of a liquid, viscous, or plastic electrolyte material. In the design example shown in FIG. 10, this layer of electrolyte material is applied by spraying this material through a spray head 40. Alternatively, the layer that forms the matrix 3 can be applied by wiping, pouring, solution casting, or dipping. In accordance with another alternative, the matrix 3 can first be produced separately as a layer of an electrolyte material, and then applied to the layer that forms the anodes 1 or cathodes 2. Preferably, the matrix 3 is applied to the cathodes 2.

In accordance with another variant, the matrix 3 can be produced from two layers, in the form of a two-layer matrix.

The channels 17, which form the (macroscopic) flow paths for conducting the fuel gas to the anodes 1 or for conducting the oxidation gas to the cathodes 2, in accordance with the design example shown in FIG. 12 (which relates to the formation of the channels 17 on the current collector 4a that supports the anode 1), are formed on the surface of the porous structure that faces away from the electrodes. In accordance with one variation, the channels 17 can be produced already during the formation of the porous structure that forms the current collectors 4a, 4b, described further above; alternatively the channels 17 can be produced on the porous structure in a subsequent step via press forming, rolling, or pressing.

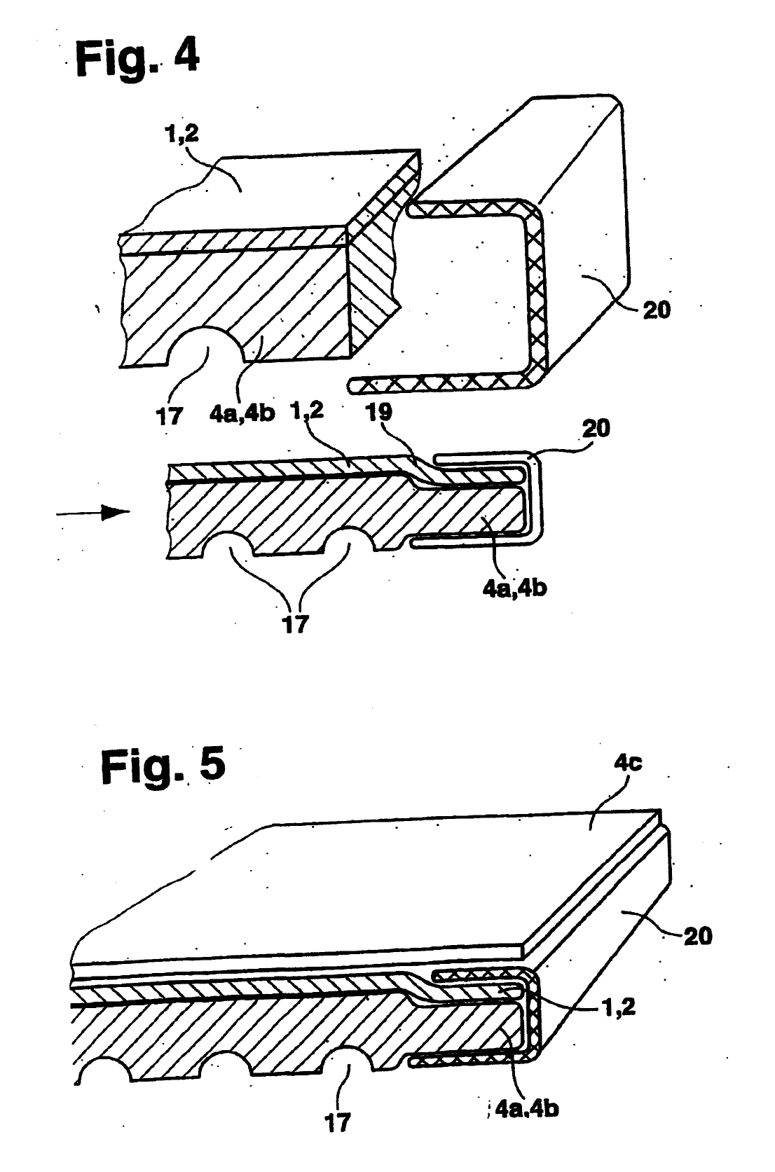

As FIGS. 4 and 5 show, in accordance with another design example of the invention, lateral sealing elements 20 are provided on the half cell formed by the anode 1 or the cathode 2 and the current collectors 4a, 4b that support them, with these sealing elements serving to seal the sides of said half cells against any escaping fuel gas or cathode gas. In the design example shown here, these sealing elements 20 are formed by U-shaped profiles, which extend around the appropriate half-cell.

As the diagram in FIG. 4 shows, a shoulder 19 that corresponds to the material thickness of the U-shaped sealing element 20 is formed on the surface of the anode 1 or cathode 2 and the current collector 4a or 4b that supports it, so that the surface of the anode 1 or cathode 2 and the current collector 4a, 4b and the opposite surface of the current collector 4a, 4b are extended smoothly by the sealing element 20, whereby an arrangement of the half cells within the fuel cell stack with an even prestressing force is ensured; compare also with FIG. 5.

In accordance with the design example shown in FIG. 5, the bipolar plates 4c are formed by flat sheets, which lie evenly on the current collector 4a or 4b.

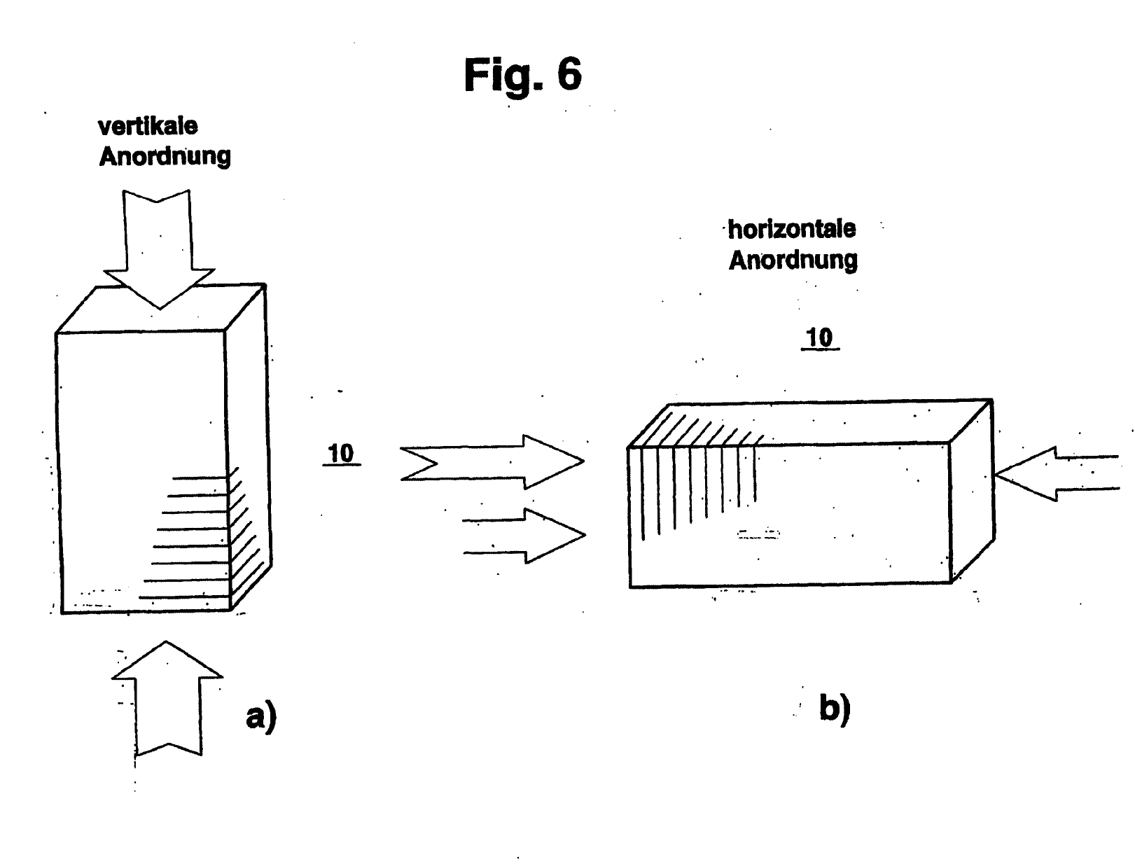

In accordance with another design example, the fuel cell stack 10 is oriented horizontally during operation, as is shown in FIG. 6b). This means that all fuel cells are subject to an even prestressing force and load, wherein the prestressing force and thus the load on the individual fuel cells is kept even and low. In this manner, any damage to the individual components of the fuel cells, and especially to the porous structure that forms the current collectors 4a, 4b, is prevented. In comparison, in a fuel cell arrangement in which the fuel cell stack 10 is oriented vertically, as is shown in FIG. 6a), the lower cells are subject to the permanent weight of the cells above them, in addition to the prestressing force, and hence are placed under far greater pressure than is advantageous to the components contained therein. Preferably, the prestressing force of the fuel cells 12 within the fuel cell stack 10 is low, and adjustable to the given operating condition of the fuel cell arrangement. Very generally, means for generating the prestressing force are provided, which generate a high level of prestressing force when the fuel cell arrangement is started up, and then subsequently reduce the prestressing force. In this manner, when the fuel cell arrangement is started up, tolerances can be balanced, while during the subsequent operation of the fuel cell arrangement the reduced prestressing force results in a reduction in the surface leakage of the components of the individual fuel cells 12. This results in a reduction of lifespan-limiting effects, and enables the use, e.g., of the described porous structure for the current collectors 4a, 4b, without their lifespan being adversely affected by a high sustained load.

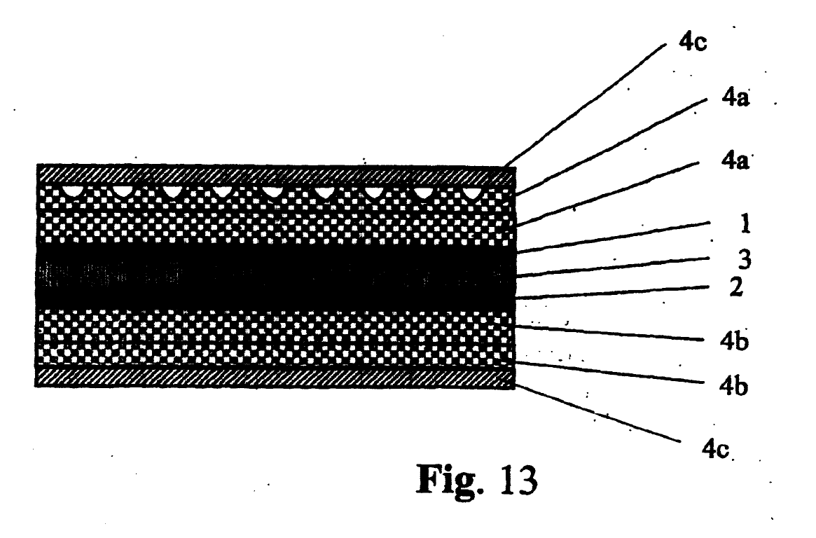

In the cell shown in FIG. 13, the current collectors 4a on the side of the anode 1 or 4b on the side of the cathode 2 are designed to be two-layered. The outer layer, which is adjacent to a bipolar plate 4c, contains flow paths 17, which are impressed in the foam structure of the current collector 4a or 4b. The total solids content of the foam structure can vary between 4 and 75%. The outer layer that contains the flow paths preferably has larger average pore sizes (0.3 to 1.2 mm) than the layers that face the electrodes, which have average pore sizes of between 0.1 and 0.7 mm. The choice of pore size (free diameter of the pores) and of the total solids content can be adjusted to fit the requirements of the given side. Larger pores are more favorable on the gas-conducting side, because in the pressing-in of the flow paths an excessive compression of the foam structure underneath the flow paths is prevented, and thus the flow resistance for the gases remains small. Small pores on the electrode side have a favorable effect in the spraying-on of the suspension. Small pore sizes minimize the sinking in of the suspension and effect thinner layers. Smaller pores also provide improved mechanical support to the active components. Furthermore, it is advantageous that additional layers containing catalyzing material can be inserted between the layers. Significantly, the pore sizes also affect production costs. Thus, with two-layer current collectors an optimized structure can be represented, while single-layer structures, in comparison, must represent a compromise.

1-32. (Cancelled)

33. (New) A fuel cell arrangement comprising:
fuel cells arranged in a fuel cell stack, each fuel cell containing an anode, a cathode, and an electrolyte matrix positioned between the anode and the cathode,
bipolar plates by which the cells are separated from one another and electrically contacted,
current collectors on the anodes electrically contacting the anodes and adapted to conduct fuel gas to the anodes, and
current collectors on the cathodes electrically contacting the cathodes and adapted to direct cathode gas to the cathodes,
wherein fuel gas and cathode gas are adapted to be directed to and from the fuel cells,
wherein the current collectors for at least one of the anodes and the cathodes are formed by a sintered porous structure, in which pores are formed as flow paths for conducting at least one of fuel gas and cathode gas,
wherein the porous structure is comprised of a foam having a total solids content of 4% to 35%, and
wherein channels are embedded in the sintered, porous structure as additional flow paths via press forming, rolling, or pressing.

34. (New) The fuel cell arrangement in accordance with claim 33, wherein the porous structure that forms the current collectors is comprised of a porous nickel-sintered material.

35. (New) The fuel cell arrangement in accordance with claim 33, wherein the porous structure that forms the current collectors is comprised of a nickel-foam material.

36. (New) The fuel cell arrangement in accordance with claim 33, wherein a surface of the porous structure is flat, apart from the flow paths.

37. (New) The fuel cell arrangement in accordance with claim 33, wherein at least one of the anode and the cathode is provided as a layer on the porous structure that forms the current collectors.

38. (New) The fuel cell arrangement in accordance with claim 33, wherein the channels are provided on a surface of the porous structure that forms the current collectors that faces away from an associated electrode.

39. (New) The fuel cell arrangement in accordance with claim 33, wherein the bipolar plates contain flat bipolar sheets positioned between the current collectors of adjacent fuel cells.

40. (New) The fuel cell arrangement in accordance with claim 33, wherein the electrolyte matrix is designed as a layer on the anode or cathode.

41. (New) The fuel cell arrangement in accordance with claim 33, and further comprising a layer of a catalyzing material applied to the porous structure that forms the current collector for the anode.

42. (New) The fuel cell arrangement in accordance with claim 33, wherein a half cell formed by the anode or the cathode and one of the current collectors that supports the anode or the cathode is laterally sealed by a sealing element which extends around the anode or cathode and the porous structure.

43. (New) The fuel cell arrangement in accordance with claim 42, wherein a shoulder is defined on a surface of the anode or the cathode and the one of the current collectors that supports the anode or the cathode, and wherein the shoulder corresponds to the material thickness of the sealing element so that the surface of the anode or the cathode and the one of the current collectors is smoothly extended by a surface of the sealing element.

44. (New) The fuel cell arrangement in accordance with claim 33, wherein the fuel cell stack is oriented horizontally in operation, and wherein a prestressing force of the fuel cells is low and variably adjustable to the operating condition of the fuel cell arrangement.

45. (New) The fuel cell arrangement in accordance with claim 44, wherein a high level of the prestressing force is generated with a start-up of the fuel cell arrangement and reduced thereafter.

46. (New) The fuel cell arrangement in accordance with claim 42, wherein the sealing element is formed as a U-shaped profiled piece.

47. (New) The fuel cell arrangement in accordance with claim 34, wherein the porous structure that forms the current collectors is comprised of a nickel-foam material.

48. (New) The fuel cell arrangement in accordance with claim 34, wherein a surface of the porous structure is flat, apart from the flow paths.

49. (New) The fuel cell arrangement in accordance with claim 35, wherein a surface of the porous structure is flat, apart from the flow paths.

50. (New) The fuel cell arrangement in accordance with claim 34, wherein at least one of the anode and the cathode is provided as a layer on the porous structure that forms the current collectors.

51. (New) The fuel cell arrangement in accordance with claim 35, wherein at least one of the anode and the cathode is provided as a layer on the porous structure that forms the current collectors.

52. (New) The fuel cell arrangement in accordance with claim 36, wherein at least one of the anode and the cathode is provided as a layer on the porous structure that forms the current collectors.
